(19) United States
(12) Patent Application Publication
(10) Pub. No.: US 2004/0011469 A1
(43) Pub. Date: Jan. 22, 2004

(54) Labeler for dispensing labels adhering to a backing strip

(76) Inventor: Howard Norris, Buderin (AU)

Correspondence Address: MASON, MASON & ALBRIGHT, 2306 South Eads Street, P.O. Box 2246, Arlington, VA, 22202, US

(21) Appl. No.: 10/325,829

(22) Filed: Dec. 23, 2002

Related U.S. Application Data
(63) Continuation of application No. PCT/NZ01/00120, filed on Jun. 23, 2001.

(51) Int. Cl. B32B 31/00

(52) U.S. Cl. 156/361; 156/360; 156/444

(57) ABSTRACT

The present invention relates to a labelling apparatus (1) for applying a label (2) to an object (3), including a sensing apparatus capable of identifying the position of an object relative to the labelling apparatus, and an applicator (19) to facilitate the application of the label onto an object at the preferred time, and a means (18) for advancing at least one label strip to which at least one label is removably adhered, and a detaching station (13) which is capable of partially detaching the adhesive label from the backing tape of the label strip, and the labeling apparatus characterised in that it includes a first pressurised air flow (18) capable of blowing air at the label to prevent the label from reattaching itself to the backing tape of the label strip, and a second sensing apparatus, capable of detecting the end of the label, and trigger means to activate a secondary air flow (19) for a time period to enable an blown from the secondary air flow to direct the label onto the object.

### TECHNICAL FIELD

This invention is directed to improvements in and relating to the application of adhesive labels on to objects. In particular, it is envisaged the methods and apparatus of this invention will have particular use in relation to the application of labels on to fruit either singularly, or via multiple application to all fruit positioned in a fruit tray.

However, this invention may have applications outside this field.

### BACKGROUND ART

There are a number of machines, apparata or processes for labelling, or dispensing labels on to objects. Some of these applications include air blast devices for applying labels, whilst others require contact between the labelling apparatus and the object to which the label is applied.

For example, New Zealand Patent No. 206735 relates to a labelling machine including a rotating labelling head. A strip of adhesive labels is carried on a reel. This strip is passed along a plate at the end of which the label is stripped from the backing and held by vacuum on a bellows. The bellows rotates. When the bellows reaches a position adjacent to the article to be labelled, the vacuum is cut and an air blast extends the bellows to fix the label on the article. The empty bellows is then retracted and rotated upwards to receive another label.

By comparison, New Zealand Patent No. 129825 relates to a device for applying labels by an air blast. The invention includes an edge plate where a label is peeled off a backing strip and is drawn under vacuum suction to an applicator box where it is held. An article is required to be placed under the applicator box in order to operate a micro-switch that causes a blast of high pressure air to be directed against the label with sufficient force capable of overcoming the holding vacuum (which is continuously operated) to cause the label to adhere to the article.

Yet other label applicators may comprise a gun/hand-held type applicator. Yet others include the use of adhesive labels on a backing strip that are contacted whilst stationary by one or more suction pads of an applicator. The backing strip may then be stripped away from the labels so they can be applied to an object.

New Zealand Patent No. 241050 relates to a further variation in the application of labels onto objects. This invention relates to a high-speed labelling machine that includes a vacuum drum for transferring labels cut from a continuous roll onto the surface of the cylindrical container. Adhesive may be applied to the label before it is transferred to the vacuum drum. The vacuum drum includes vacuum ports to hold the label on the drum, and air jets that force the label against the container. The air jets are said to result in a more efficient transfer of the label and aids in maintaining the label in place on the container until the adhesive has dried.

Whilst all of these particular inventions may demonstrate success in applying labels to objects, there are a number of disadvantages. For example, the invention as described in New Zealand Patent No. 206735 requires that a specific vacuum be created on a bellows. There is requirement for a separate vacuum generating apparatus and an air blast apparatus to enable the label to be held in an appropriate location for application and then to be positioned adjacent an article so the label can be fixed to the article. Any problems in generating the vacuum can affect the operation of this particular apparatus.

Further, where the article to which the label is being attached is a fruit that may be easily bruised, the contact between the surface of the fruit and the label fixed to the bellows may result in unwanted damage to the fruit.

In addition, the bellows operates such that the labels are sequentially applied to fruit passing beneath the bellows. There is no ability other than having multiple rings of bellows to effect application of more than one label to more than one article at a time.

Where devices are used for applying labels via an air blast, such apparatus also appears to require a separate vacuum station and a separate air jet source to direct the label from a holding vacuum and onto an article passing below the vacuum station. Accordingly, the issue of creating a separate vacuum in order for this apparatus to operate is similar to that of the previously described invention.

Whether the vacuum is created at a single vacuum station or whether the apparatus is a high speed labelling machine with a vacuum drum transferring labels cut from a continuous roll held onto the drum via a vacuum port and then requiring separate edges to force the label against a container, there are similar problems associated with these inventions.

Inventions used for applying adhesive labels using a hand-held applicator have obvious disadvantages. The speed with which the labels may be applied is dependent upon the individual operator of the hand-held applicator. In addition, the ability to apply more than one label at one time to a range of articles is limited.

It would therefore be advantageous to have an apparatus for applying labels to an object or multiple objects where:

a) the labels can be applied at high speed; and

b) the labels can be applied to one or more objects simultaneously; and

c) the apparatus does not require a separate cutting station, vacuum station, air blast station, adhesive applying station and so forth; and

d) is thereby is able to overcome some of the difficulties identified with prior art systems in terms of speed, complexity of the apparatus, and the application of labels onto a number of objects simultaneously; and

e) where the position of the object is able to be detected without the positioning of the object crowding the area where the apparatus for applying the label to the object is operating.

It is an object of the present invention to at least address the foregoing problems or to provide the general public with an alternative system.

Further aspects and advantages of the present invention will become apparent from the ensuing description that is given by way of example only.

### DISCLOSURE OF INVENTION

According to one aspect of the present invention there is provided labelling apparatus for applying at least one label to at least one object, said labelling apparatus including;

sensing apparatus capable of identifying the position of an object relative to the labelling apparatus, said sensing apparatus being in communication with

an applicator to facilitate application of a label on to an object at a preferred time, and said labelling apparatus also including

a means for advancing at least one label strip to which a plurality of labels is removably adhered thereon to

a detaching station capable of partially detaching the adhesive label from the backing tape of the label strip,

characterised in that it includes

a first pressurised air source capable of blowing air at the label to prevent the label from re-attaching itself to the backing tape, and

a second sensing apparatus capable of detecting the end of the label, and

trigger means to activate a secondary air flow for a time period to enable air blown from the secondary air flow to direct the label onto the object.

The sensing apparatus may include a sensor capable of detecting the size of the object.

This sensor may in some embodiments be a photo-electric sensor.

In other embodiments, an external signal may provide the apparatus with an indication of the size of the object.

The photo-electric sensor, or object detector may be positioned at the front of the apparatus.

These may be synchronised by a shift register in a regulating electronic control board to allow the position of the object to be determined without the object crowding the area around the label application station.

The label strip may include a backing tape with a plurality of labels that are removably adhered thereto.

This label strip may be guided by pulley systems to present the label strip to at least one drive wheel that is capable of driving the label strip in a substantially forward direction. The drive wheel may be turned until one complete label has passed a sensing apparatus monitoring the position of the label relative to the position of the object to be labelled.

In some preferred embodiments of the present invention once the label strip has passed the sensing apparatus the label strip may be forced over a detaching apparatus in a manner that only partially detaches the label from the backing tape.

However, in some other preferred embodiments of the present invention the action of the moving backing tape is utilised to detach the label from the label strip.

The primary air source may be substantially elongate and includes air aperture(s) in at least one surface, such that air passing through the aperture(s) creates a pressurised air flow capable of blowing air at the label thereby preventing the label from it reattaching itself to the backing tape.

The labelling apparatus may be operated by any one of a reticulated air supply, individual air compressors, or any other means capable of providing at least one pressurised air flow when required.

According to another aspect of the present invention there is provided

a method of using a labelling apparatus to apply a label to an object, including

a first sensing apparatus, and

a label feeding assembly, and

a detaching apparatus, and

a first air flow, and

a second sensing apparatus, and

a second air flow and

a label strip containing at least one detachable label,

characterised by the steps of

a) sensing with the first sensing apparatus either or both the position and the size of the object in order to position the object in a preferred location; and

b) guiding, via the label feeding assembly, the label strip towards the position of the object until one complete label has passed the label sensing apparatus; and

c) forcing the label strip over the detaching apparatus to effect partial detachment of the label from the backing tape; and

d) operating the first air flow to direct a flow of air at the label to prevent it from re-attaching itself to the backing tape; and

e) sensing when the end of the label has been detached from the label strip, and

f) initiating the secondary air flow to direct the label onto the object.

Preferred embodiments of the present invention require a readily available label source, such as a spool onto which a label strip is fitted. The label strip includes a number of self-adhesive labels applied to a non-adhesive backing strip.

During operation the labelling apparatus feeds the label strip from the label spool to a delivery point from where the label is delivered to the object when required.

As can be appreciated, any suitable substitution to the above may be adapted for use with the present invention.

To ensure the label strip is ideally presented to the delivery point the labelling apparatus includes a driving mechanism. The driving mechanism preferably includes at least one pulley to assist in feeding the label strip in a preferred direction and at a preferred tension in order to enable the labels to be correctly presented at the delivery point.

The driving mechanism also therefore includes at least one drive wheel and at least one pressure wheel, which is used to apply the required frictional force against the label strip and the drive wheel, to both facilitate movement of the label source from the label spool and to ensure that the label is delivered at the appropriate time.

A sensing apparatus is located at an appropriate point along the route of the label to the delivery point.

In preferred embodiments the sensing apparatus includes a label photo-sensor, although this should not be seen to be a limitation on the present invention in any way as any suitable sensing apparatus may be employed with the invention.

The photo-sensor monitors the position of the label with respect to the position of the object to which the label will be applied.

In preferred embodiments of the present invention, a drive wheel is turned until one complete label has passed the label photo-sensor.

A stepper motor is utilised at this point in the apparatus in order to compensate for the inherent high detent force and therefore prevent overrun of the label. Any suitable compensation means may be employed although a stepper motor is preferred. Operation of the drive wheel in conjunction with the stepper motor accurately presents the label to the delivery point

Within the present specification the labelling process is triggered by one of two things, either a photo-electric sensor detects an object or the apparatus receives a signal indicative of the object's size.

The labelling apparatus is timed to the sizing operation by at least one sensing apparatus which may be linked to the photo-electric sensor that detects the object. The invention may include multiple sensing apparatus associated with the different stages of the labelling process and the presentation of the object for labelling.

The object detector may be positioned at the front of the labelling apparatus and can be synchronised by a shift register in the electronic control board of the object detector.

This will allow the position of the object to be determined without the object or the object detector crowding the area around the delivery point at which the label is delivered to an object.

In preferred embodiments of the present invention there is a detaching apparatus for at least partially detaching the label from the backing strip.

A knife-edge, or step is generally used with the present invention, however this is not always necessary as the action of the moving backing tape can be utilised to detach the label.

The label source can be forced over the detaching apparatus so that the label becomes partially detached from the backing strip. As the label is partially detached from the backing strip; a first air source can be activated.

The first air source is preferably provided as a flow of air through an air amplifier such as a venturi, although a substantially fluted, narrow or otherwise configured arrangement on the primary air source delivery apparatus may be used if desired.

In preferred embodiments of the present invention a tube can be fitted inside the air amplifier and close to where the label is detached as air blowing out of the tube causes air to be drawn through the air amplifier.

The air passing through the air amplifier results in a flow of air which is blown at the label preventing the label from re-attaching itself to the backing strip.

The offset knife/air flow relationship may be configured such that the trailing edge of the label is caused to detach from the backing tape as a result of the tension effected by the label bending.

When the electronic sensing apparatus of the invention senses that the end of the label has passed a certain point a second air flow is activated and the primary air source can be turned off. The second air flow is emitted from the air amplifier and forces the label onto the object.

The air supply changeover from the first air flow to the second air flow is preferably effected by a five port air valve.

After the label has been detached from the backing strip, the backing strip may travel over and around the knife-edge and may be directed away from the delivery point past the drive wheel and to a backing spool around which the backing strip is fed and retained.

Tension is preferably maintained on the backing strip during its delivery to the backing spool via a pressure wheel forcing the backing strip against the drive wheel. The empty backing strip may be rewound via operation of a low power, low speed motor.

The above sequence can be repeated as many times as required to apply the labels to the number of objects requiring labelling.

As can be appreciated, variations are possible to the componentry of the above apparatus. For example, the stepping motor driving the drive wheel may be air operated, hydraulic, or any geared electric motor.

The pulleys or idling points may be other structures than pulley wheels, for instance they may be solid bars and so forth.

Whilst it is envisaged a reticulated air supply will be available to drive the labelling apparatus it should be appreciated that individual air compressors or any other suitable form of air supply could be used.

Preferably all frame work associated with the invention is of mild steel. The pulleys are preferably plastic but could also be metallic or manufactured from any other suitable material, as may be the tension wheels or the drive wheel (which is preferably made of aluminium).

It should also be appreciated that there are a number of alternative uses for the invention as almost any label applicator could benefit from the principles of this invention. The air application enables irregular objects to be more easily labelled.

In addition, with only a few moving parts a greater speed of operation is easier to achieve. Without direct physical contact of the applicator onto an object such as fruit, problems of bruising or other damage are minimised.

It should be appreciated that whilst the description has been directed primarily to the application of a single label to a single object, delivery of labels to multiple objects may also be achieved. For example, the label source may include multiple rows of labels that are fed across an extended first air source and an extended second air source may apply the labels detached from the backing strip onto a number of objects positioned to be labelled. Accordingly, the labelling apparatus may used to apply labels to individual fruit/objects, or an entire tray of fruit may be labelled a row at a time or, by other modifications to the invention, tray at a time.

Accordingly, the terminology or description herein should not be seen to limit the scope of this invention.

### BRIEF DESCRIPTION OF DRAWINGS

Further aspects of the present invention will become apparent from the following description which is given by way of example only and with reference to the accompanying drawings in which:

FIG. 1 a diagrammatic side view of the componentry of the labelling apparatus for applying a label to an object in accordance with one preferred embodiment of the present invention.

FIG. 2 a diagrammatic plan view of the external surface of the secondary air source in accordance with one preferred embodiment of the present invention, and

FIG. 3 the diagrammatic top plan view of the side surface and the air jets from the side of the primary air source in accordance with one preferred embodiment of the present invention.

### BEST MODES FOR CARRYING OUT THE INVENTION

With reference to the diagrams by way of example only there is provided apparatus (generally indicated by arrow 1) for applying a label (2) to an object (3).

The process of delivering a label (2) to the object (3) is triggered by one of two things. A photo-electric sensor (not shown) detects an object (3) or a signal from a host sizer computer (not shown). The labelling apparatus (1) is timed to the sizing computer/machine by the same or additional sensing apparatus linked to or separate from the photo-electric sensor that detects the object.

The object detector is positioned at the front of the labelling apparatus (1) and is synchronised by a shift register in the electronic control board of the object detector, to allow the position of the object (3) to be determined, without the object (3), or the object detector crowding the area around the delivery point (7) at which the label (2) is delivered to an object (3).

The apparatus (1) includes a label source (4). The label source (4) includes a spool (5) onto which a label strip (4) is fitted. The label strip (4) includes multiple, self-adhesive labels (2) applied to a non-adhesive backing strip (6). During operation, the labelling apparatus (1) operates to feed the label strip (4) from the label spool (5) to a delivery point (7) where the label (2) is delivered to the object (3).

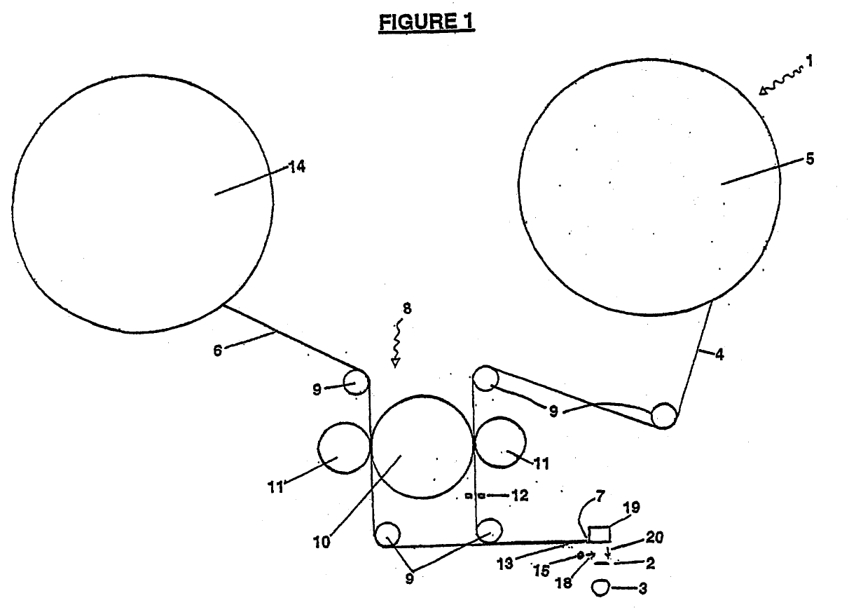

Sensing apparatus (12) is included along the delivery route of the label strip (4) as the label strip moves towards the delivery point (7). The sensing apparatus includes a label photo-sensor (12) to monitor the position of the label ultimately relative to the position of the object (3) to which the label (2) will be applied. Not shown in FIG. 1 is a stepper motor employed at this point in the apparatus. The stepping motor is required because of the inherent high detent force to prevent overrun of the label. As can be appreciated, variations are possible to the componentry of the above apparatus. For example, the stepping motor, driving the drive wheel (10), may be air operated, hydraulic, or any geared electric motor.

To ensure the label strip (4) is ideally presented to the delivery point (7) the apparatus includes a driving mechanism (8). The driving mechanism (8) includes multiple pulleys/idling points(9) to direct the label strip, and pressure wheels (11) to maintain tension on the label strip (4) to enable the label strip (4) to be optimally presented at the delivery point (7). The driving mechanism (8) also includes a drive wheel (10) that co-operates with the at least two pressure wheels (11) to force the label strip (4) against the drive wheel (10) to facilitate movement of the label strip (4) from the label spool (5). The pulleys or idling points (9) may be other than pulley wheels and may, for example be solid bars and so forth.

Operation of the drive wheel (10) in conjunction with the stepper motor (not shown) presents the label source (4) to the delivery point (7). The drive wheel (10) is turned until one complete label (2) has past the label photo-sensor (12).

At the delivery point (7) there is included a knife edge (13). The label source (4) is forced over the knife edge (13) such that a label (2) becomes partially detached from the backing strip (6).

As the label (2) is partially detached from the backing strip (6) (at the delivery point (7)), a primary air source (15) is activated. This primary air source (15) is provided via a blast of air through multiple air jets (16) arranged along a side surface of the primary air source (15).

FIG. 3 illustrates a top plan view of the primary air source (15) showing that multiple air jets (16) arranged substantially linearly along the side surface (17) of the primary air source (15). As can be appreciated however, the arrangements of the air jets (16) can be varied as required as can the number of air jets, or their position on or around the primary air source.

The air passing through the air jets (16) of the primary air source (15) results in what amounts to an air curtain the direction of which is shown at arrow 18.

Effectively, the air curtain (18) produced by the primary air source tube (15) and its associated apertures/holes (16), operates like a flute, and blows air across the label (2) preventing the label from re-attaching itself to the backing strip (6).

The action of the air also forms an area of low pressure beneath the secondary air source, or air nozzle (19).

The offset knife (13)/air nozzle (19) configuration causes the trailing edge of the label (2) to detach from the backing tape (6) because of tension created by the label (2) bending.

When electronic sensing apparatus senses the end of the label transfer, the primary air source (15) and correspondingly the air curtain (18) is turned off, and a secondary air flow via the air nozzle (19) is turned on.

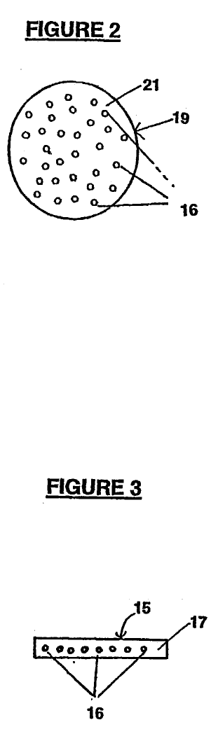

The bottom surface of the air nozzle is configured like a miniature shower rose (as shown in FIG. 2), having multiple holes through which the air is directed downwards. Air is blown out of the air nozzle (19), in a delivery blast as shown by arrow 20. The air blown from the air nozzle (19) forces the label (2) onto the object (3). The delivery blast is intermittent, the duration of which is sufficient to deposit the label onto the surface of the object positioned beneath the nozzle.

A five port air valve effects the air changeover between the primary and secondary air sources. Whilst it is envisaged that a reticulated air supply will be available to drive the labelling apparatus (1), it should be appreciated that individual air compressors could also be used.

The label strip (4) then travels over and around the knife edge (13) and at this stage the remaining backing strip is directed away from the delivery point (7) passed the drive wheel (10) and to a backing spool (14) around which the backing strip (6) is fed and retained. The empty backing strip (6) is rewound onto the backing spool (14) via operation of a low power, low speed motor (not shown).

Again, tension is maintained on the backing strip (6) during its delivery to the backing spool (14) as a result of the positioning of various pulley/idling points (9) and by a pressure wheel (11). Pressure is applied by the pressure wheel (11) to the backing strip (6) fed between the pressure wheel (11) and the drive wheel (10).

The above sequence is repeated as many times as required to apply the labels (2) to the number of objects (3) requiring labelling. Almost any label applicator (1) could benefit from the principles of this invention. The air application enables irregular objects (3) to be easier to label. In addition, few moving parts mean speed of operation is easier to achieve. Also as can be appreciated there are a number of alternative uses for the invention whether the labels are applied to single objects sequentially, or multiple objects at the same time.

Preferably all frame work is of mild steel, the pulleys are preferably plastic but could also be metallic or any other suitable material, as may be the tension wheels or the drive wheel (the latter of which is preferably made of aluminium).

Aspects of the present invention have been described by way of example only and it should be appreciated that modifications and additions may be made thereto without departing from the scope of the amended claims.

What we claim is:

1. A labelling apparatus for applying a label to an object, including
a sensing apparatus capable of identifying the position of an object relative to the labelling apparatus, and
an applicator to facilitate the application of the label onto an object at the preferred time, and
a means for advancing at least one label strip to which at least one label is removably adhered, and
a detaching station which is capable of partially detaching the adhesive label from the backing tape of the label strip, and
the labelling apparatus characterised in that it includes
a first pressurised air flow capable of blowing air at the label to prevent the label from reattaching itself to the backing tape of the label strip, and
a second sensing apparatus, capable of detecting the end of the label, and
trigger means to activate a secondary air flow for a time period to enable air blown from the secondary air flow to direct the label onto the object.

2. A labelling apparatus as claimed in claim 1 wherein the sensing apparatus includes at least one sensor that is capable of detecting the size of the object.

3. A labelling apparatus as claimed in any previous claim wherein the first sensing apparatus is positioned towards the front of the labelling apparatus to determine the position of the object to which it is desired to affix a label.

4. A labelling apparatus as claimed in any previous claim wherein the label strip is drawn into the apparatus until one complete label has passed the second sensing apparatus, at which point the label strip is forced over the detaching apparatus in a manner that partially detaches the label from the backing tape of the label strip.

5. A labelling apparatus as claimed in claim 4 wherein a pressurised air flow is directed at the partially detached label in a manner that will prevent the label from reattaching to the backing tape of the label strip.

6. A labelling apparatus as claimed in any previous claim wherein once the second sensing apparatus senses the end of the label the first air flow is terminated and the second air flow is initiated so as to force the detached label onto the object.

7. A method of using a labelling apparatus to apply a label to an object, including
a first sensing apparatus, and
a label feeding assembly, and
a detaching apparatus, and
a first air flow, and
a second sensing apparatus, and
a second air flow and
a label strip containing at least one detachable label,
characterised by the steps of
a) sensing with the first sensing apparatus either or both the position and the size of the object in order to position the object in a preferred location; and
b) guiding via the label feeding assembly the label strip towards the position of the object until one complete label has passed the label sensing apparatus; and
c) forcing the label strip over the detaching apparatus to effect partial detachment of the label from the backing tape; and
d) operating the first air flow to direct a flow of air at the label to prevent it from re-attaching itself to the backing tape; and
e) sensing that the end of the label has been detached from the label strip,
f) initiating the second air flow to direct the label onto the object.

8. A label attaching apparatus substantially as herein described with reference to and as illustrated by the accompanying drawings.

9. A method of attaching labels substantially as herein described with reference to and as illustrated by the accompanying drawings.
